(19) United States
(12) Patent Application Publication
(10) Pub. No.: US 2013/0108770 A1
(43) Pub. Date: May 2, 2013

(54) NON-DAIRY FOOD ADDITIVE COMPRISING A NATURAL NON-NUTRITIVE SWEETENER

(71) Applicant: Kristina Louise LaFirenza, Erie, CO (US)

(72) Inventor: Kristina Louise LaFirenza, Erie, CO (US)

(73) Assignee: WhiteWave Services, Inc., Dallas, TX (US)

(21) Appl. No.: 13/286,663

(22) Filed: Nov. 1, 2011

(51) Int. Cl. A23L 1/19

(52) U.S. Cl. 426/610; 426/613

(57) ABSTRACT

In one embodiment, a non-dairy cream includes a non-dairy base, a natural non-nutritive sweetener, and one or more stabilizers. The natural non-nutritive sweetener provides a sweet taste to the non-dairy cream. The stabilizer(s) facilitate maintaining the non-dairy cream in a substantially uniform liquid suspension.

### TECHNICAL FIELD OF THE DISCLOSURE

This invention relates in general to food additives and, more particularly, to a non-dairy food additive comprising a natural non-nutritive sweetener.

### BACKGROUND

Non-dairy food additives, such as non-dairy creamers, may include added sugar to yield a flavor profile that improves consumer acceptance. Sugar may be added in the form of liquid sugar, crystallized sugar, honey, agave, or other sweeteners, such as high fructose corn syrup and/or corn syrup. Adding sugar, however, may add calories which may be considered unfavorable to health or diet conscious consumers. Artificial sweeteners, such as sucralose, aspartame, and saccharine, may provide a low-calorie alternative to sugar. Artificial sweeteners, however, may have an undesirable flavor or aftertaste and may include chemicals that do not appeal to health conscious consumers.

### SUMMARY

In one embodiment, a non-dairy cream includes a non-dairy base, a natural non-nutritive sweetener, and one or more stabilizers. The natural non-nutritive sweetener provides a sweet taste to the non-dairy cream. The stabilizer(s) facilitate maintaining the non-dairy cream in a substantially uniform liquid suspension.

Certain embodiments of the present disclosure may provide one or more technical advantages. As an example, in some embodiments, the amount of calories required to optimally sweeten a non-dairy food additive may be reduced. As another example, in some embodiments, the non-dairy food additive may be sweetened using naturally-derived, plant-based sweeteners or other naturally-derived sweeteners.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example of a system for producing a non-dairy food additive comprising a natural non-nutritive sweetener; and

FIG. 2 illustrates an example of a method for producing a non-dairy food additive comprising a natural non-nutritive sweetener.

### DETAILED DESCRIPTION

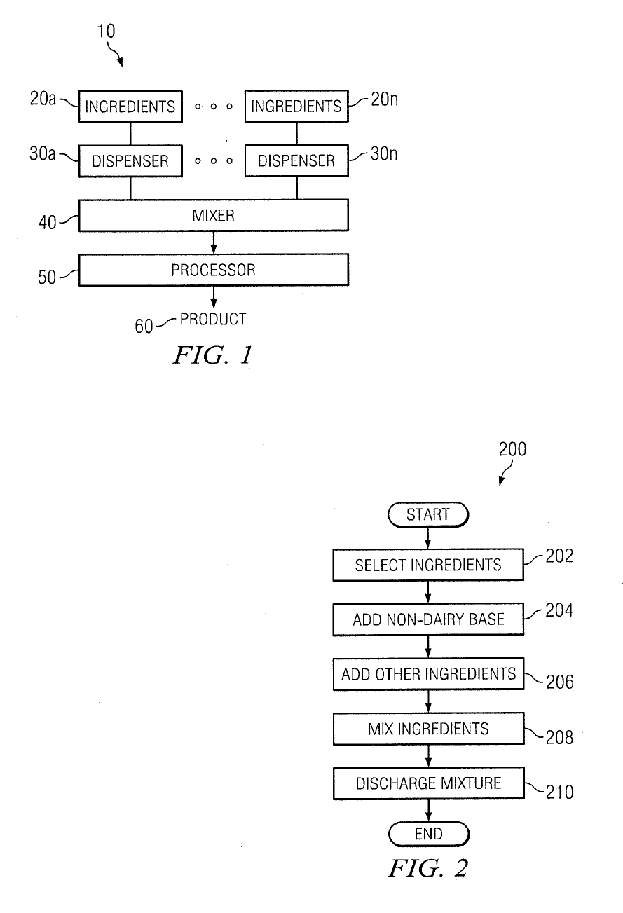

Embodiments of the present invention and its advantages are best understood by referring to FIGS. 1 to 2 of the drawings, like numerals being used for like and corresponding parts of the various drawings.

Non-dairy food additives, such as non-dairy creamers, may include added sugar to yield a flavor profile that improves consumer acceptance. Sugar may be added in the form of liquid sugar, crystallized sugar, honey, agave, or other sweeteners, such as high fructose corn syrup and/or corn syrup. Adding sugar, however, may add calories which may be considered unfavorable to health or diet conscious consumers. Artificial sweeteners, such as sucralose, aspartame, and saccharine, may provide a low-calorie alternative to sugar. Artificial sweeteners, however, may have an undesirable flavor or aftertaste and may include chemicals that do not appeal to health conscious consumers. Accordingly, in some embodiments, a naturally-derived plant-based or other naturally derived non-nutritive sweetener may be used to sweeten food additives while adding fewer calories than sugar sweeteners and without adding artificial ingredients. The non-dairy food additive may be added to a food in order to impart sweetness and/or flavor. For example, in certain embodiments the non-dairy food additive may comprise a non-dairy cream. Examples of non-dairy cream products include a non-dairy whipped topping added to desserts and a non-dairy creamer (e.g., a whitener) added to beverage-type foods. Examples of beverage-type foods include coffee, tea, alcohol, juice, etc. Beverage-type foods may be hot (e.g., greater than approximately 77° F., such as greater than 150° F.) or cold (e.g., less than or equal to approximately 77° F., such as less than 60° F.).

FIG. 1 illustrates an example of a system 10 for producing a non-dairy food additive comprising a natural non-nutritive sweetener. In some embodiments, system 10 may include one or more ingredients 20, one or more dispensers 30, a mixer 40, a processor 50, and product 60.

In operation, an operator of system 10 selects appropriate ingredients 20 for the desired product 60, and one or more dispensers 30 introduce the selected ingredients 20 into mixer 40. After an appropriate mixing time, the mixture may be discharged into processor 50 manually or through one or more nozzles, hoses, spigots, or other appropriate discharging outlet. Processor 50 processes the mixture to yield product 60.

Ingredients 20 represent constituent elements of product 60 that are deposited, mixed or combined, and discharged from mixer 40. Examples of ingredients 40 may include, but are not limited to, sweeteners, stabilizers, vitamins, minerals, nutrients, flavors, extracts, coloring agents, functional ingredients, and other ingredients including water and/or dairy milk alternatives (e.g., soy milk, nut milk, cereal-based milk, or other plant-based milk).

Sweeteners may be added to enhance the taste of flavoring ingredients and/or to provide overall sweetness to product 60. In particular embodiments, sweeteners may include, but are not limited to, one or more natural non-nutritive sweeteners, such as luo han guo or stevia, including any compound or extract derived from the natural source (e.g., mogrosides, siamenoside, neomogroside, or other derivatives of the luo han guo plant, or steviol glycosides, such as rebiana-A, rebaudioside-A, reb-A, or other derivatives of the stevia plant). In certain embodiments, the natural non-nutritive sweetener may provide a desired level of sweetness without including sugar as an ingredient 20 of product 60. In alternative embodiments, product 60 may include the natural non-nutritive sweetener and a nutritive sweetener, such as sugar, high fructose corn syrup, and/or corn syrup. Because the natural non-nutritive sweetener contributes to sweetening product 60, the amount of nutritive sweetener required to provide a desired level of sweetness may be reduced. In some embodiments the natural non-nutritive sweetener may be co-processed with other sweeteners. As an example, stevia may be co-processed with sugar by blending, co-crystallization, plating (e.g., applying a solution of stevia and water to sugar crystals and allowing the stevia to dry on the surface of the sugar crystals), or other co-processing.

Stabilizers may be added to the mixture to prevent separation or precipitation of product 60 once deposited in a package or container. Vitamins and minerals may be added to enhance the nutritional profile of product 60. Flavors may be added to enhance and/or change the taste of product 60. For example, flavors may include, but are not limited to, amaretto, chocolate, cocoa, toffee, almond, vanilla, hazelnut, caramel, Irish crème, butter pecan, mint, cinnamon, pumpkin, strawberry, raspberry, other fruit flavorings, or any other appropriate extracts, chemical compounds, or natural additives suitable to provide the described function. The combination of ingredients 20 included in product 60 may be selected to yield any suitable fat content. For example, ingredients 20 may include a full fat, reduced fat, low fat, or fat free non-dairy base or a water base.

Dispensers 30 measure ingredients 20, hold ingredients 20 prior to dispensing, pre-combine certain ingredients (e.g., dry ingredients), maintain ingredients 20 at a particular temperature, and/or dispense ingredients 20 into mixer 40. Ingredients 20 may be added serially (i.e., one at time), collectively (i.e., all ingredients are added substantially at once), or a combination (i.e., certain subsets of ingredients are pre-combined, and the combination is added serially with other ingredients or ingredient combinations). Ingredients 20 may be dispensed from dispenser 30 manually or through one or more nozzles, hoses, spigots, or other appropriate discharging outlet.

In some embodiments, mixer 40 may combine ingredients 20. Mixer 40 may comprise any appropriate container suitable to receive, mix, and/or discharge one or more ingredients 20. In particular embodiments, mixer 40 may comprise a stainless steel chamber of any suitable size. For example, mixer 40 may be sized to mix ingredients 20 in large batches that may later be divided into smaller sizes suitable for sales to consumers, or mixer 40 may be sized to mix smaller, individual-sized portions.

Mixer 40 may receive ingredients 20 through one or more different inlets. For example, a non-dairy base (e.g., water, oils, non-dairy milk alternatives, etc.) may be added to the mixing chamber through one or more nozzle and hose inlets, and other ingredients 20, such as sweeteners, flavors, and/or stabilizers, may be added through one or more openings in mixer 40. Mixer 40 may include one or more means for blending, mixing, combining, stirring, and/or agitating ingredients 20. For example, mixer 40 may include mechanical agitators, pressure jets, or other suitable mixing devices, whether located within mixer 40 or external to mixer 40. Alternatively, mixer 40 may allow for stirring or mixing by hand. In some embodiments, mixer 40 may be chilled (depending on the particular ingredients 20 used) to prevent spoliation of one or more ingredients 20 during mixing and/or processing. Accordingly, mixer 40 may include a jacketed or insulated tank to maintain appropriate temperatures. Mixer 40 may also include one or more discharge outlets connected to other components of system 10. For example, mixer 40 may include one or more discharge outlets connected to hoses or tubes, which may carry the mixture to processor 50.

Processor 50 may comprise one or more components for further processing the mixture. As an example, processor 50 may include means for pasteurizing the mixture. Pasteurization may refer to heating the product to a temperature (e.g., 160 to 320° F.) and holding it at the temperature for a period of time (e.g., 1 to 30 seconds) to reduce the number of viable pathogenic micro-organisms in the product. Examples of pasteurization techniques include both ultra pasteurization (UP) and ultra high temperature pasteurization (UHT) where the mixture may be held at a temperature in the range of approximately 280 to 320° F. for approximately 2 to 30 seconds, aseptic pasteurization where the mixture may be held at a temperature in the range of approximately 285 to 320° F. for approximately 2 to 30 seconds, and other pasteurization techniques. As another example, processor 50 may include a homogenizer or other means for reducing particle size so that particle distribution may be maintained and mouthfeel may be improved. In certain embodiments, multiple-stage homogenization may be used, such as two-stage homogenization. In the first stage, the homogenization pressure may be between approximately 0 to 3000 psi, and in the second stage the homogenization pressure may be between approximately 0 to 1000 psi. The product may be homogenized prior to and/or after pasteurization.

In some embodiments, product 60 may be directed from processor 50 to temperature controlled storage or to packaging, bottling, or filling components suitable to ready product 60 for commercial sale or use. For example, packaging components may deposit an amount of the mixture into one or more bottles, jars, cans, cartons, and/or any other appropriate container.

In particular embodiments, product 60 comprises a flavored or non-flavored non-dairy cream. In general, however, product 60 may represent any sweetened food additive. In particular embodiments, system 10 may provide a reduced calorie product 60 that has a flavor profile similar to a primarily sucrose-sweetened product. In certain embodiments, product 60 may comprise an all-natural sweetened food additive. Accordingly, product 60 may have a sweetened flavor profile free of the unpleasant aftertaste associated with artificial sweeteners. Particular embodiments may provide some, none, or all of these operational benefits, and may provide additional operational benefits.

Modifications, additions, or omissions may be made to system 10 without departing from the scope of the invention. The components of system 10 may be integrated or separated. Moreover, the operations of system 10 may be performed by more, fewer, or other components.

FIG. 2 is a flow diagram illustrating a method 200 for making a non-dairy food additive comprising a natural non-nutritive sweetener. The method begins at step 202 where appropriate ingredients are selected. In some embodiments, the ingredients may include a non-dairy base, a natural non-nutritive sweetener, and one or more sweeteners, stabilizers, vitamins, minerals, nutrients, flavors, functional ingredients, and/or antioxidants.

In certain embodiments, the non-dairy base may be substantially free of dairy milk (e.g., cow's milk, goat's milk, sheep's milk, or other dairy livestock's milk). Examples of the non-dairy base include water, oils, or dairy milk alternatives (e.g., soy milk, nut milk, cereal-based milk, or other plant-based milk). In certain embodiments, the amount of non-dairy base may be in the range of approximately 20 to 99%, 30 to 90%, 40 to 80%, or 50 to 70% of the formulation.

Sweeteners may be natural, artificial, and/or non-nutritive and may function to make the products taste more appealing. Depending on their sweetening power, natural non-nutritive sweeteners may comprise approximately 1 ppm to 5% of the formula, such as 2 ppm to 1% or 3 ppm to 0.05%. Natural non-nutritive sweeteners, including, but not limited to, luo han guo, stevia, or their derivatives, may be used as a low-calorie alternative to or in combination with one or more other sweeteners, such as other natural non-nutritive sweeteners, nutritive sweeteners (e.g., sugar, liquid sugar, crystallized sugar, honey, agave, cane juice, high fructose corn syrup, corn syrup, etc.), and/or artificial sweeteners (e.g., sucralose, aspartame, saccharine, etc.). In some embodiments, an amount of nutritive sweetener to be combined with the natural non-nutritive sweetener may be selected to yield a selected sweetness level and selected number of calories, while minimizing metallic or bitter flavors that may be associated with the natural non-nutritive sweetener alone. In certain embodiments, the nutritive sweetener (or the combination of nutritive sweeteners) may comprise less than 50%, less than 45%, less than 35%, less than 20%, less than 10%, less than 5%, less than 1%, or 0% of the formula.

Stabilizers enhance physical properties of beverages by imparting viscosity or mouthfeel properties or acting as buffering agents. Stabilizers may contribute to prolonging the shelf-life of the product, for example, by stabilizing and or suspending insoluble materials and preventing separation or settling of ingredients. Stabilizers may be natural or artificial and may include, but are not limited to, emulsifiers (e.g., polysorbates), starches (e.g., maltodextrin), hydrocolloids (e.g., gels or gums, such as guar, acacia, locust bean, xanthan, gellan, carrageenan, cellulose, and pectin), salts (e.g., sodium stearoyl lactylate, sodium citrate, sodium chloride, potassium citrate, potassium phosphate, and dipotassium phosphate), lipids (e.g., monoglycerides, diglycerides, and vegetable oils, such as palm oil), proteins (e.g., sodium caseinate), and so on. Any suitable stabilizer or combination of stabilizers may be used to yield the desired properties of the product. For example, in certain embodiments the stabilizers may be selected to maintain a substantially uniform liquid suspension when mixed with a coffee beverage (hot or cold) or other beverage-type foods.

Vitamins and minerals may be added to fortify products. Examples include A, vitamin D, vitamin E, vitamin B6, vitamin B12, vitamin C, iron, potassium, phosphorous and/or calcium, however, any suitable vitamins and/or minerals may be used. Any suitable ingredient may be used as a vitamin or mineral source. The vitamin and mineral sources may be selected so that sodium levels in the product do not spike and that proper pH levels are maintained. The amount of vitamins and minerals may be selected to provide a desired level of fortification, for example, based on daily recommended values (DRVs).

Natural and artificial flavors and flavoring ingredients including extracts of plant materials, cocoa powder, milk based ingredients, and compounded flavors, impart desired taste attributes to products. They are used at various levels depending on the strength and the desired end product attributes. Approximate ranges of flavoring ingredients may vary from 0 to 5% depending on desired product properties.

Functional ingredients like fiber, plant sterols, etc. may be added to enhance functionality of products.

Antioxidants may prevent and/or reduce oxidation and may preserve the flavor and appearance of the product during refrigerated and/or unrefrigerated storage. Examples of antioxidants may include BHA, BHT, propyl gallate, tocopherols, and salts of ascorbic acid, such as sodium ascorbate.

Although ingredients in the preceding examples have been used to illustrate certain properties, certain ingredients may be characterized by more than one property. As an example, dipotassium phosphate may provide stabilization to the product and may fortify the product with potassium and phosphorous.

The following tables illustrate examples of a non-dairy food additive formula comprising a natural non-nutritive sweetener in combination with other ingredients to impart desirable taste profile and low calorie content. Dry ingredients may be weighed according to the formula and blended together.

TABLE 1
Reduced Sugar Flavored Creamer

| INGREDIENT | APPROXIMATE RANGE | EXAMPLE RANGE |
|---|---|---|
| Water | Balance | Balance |
| Carrageenan | 0-5% | 0.01-1% |
| Mono & Diglycerides | 0-5% | 0.01-1% |
| Sodium Stearoyl Lactylate | 0-5% | 0.01-1% |
| Salt | 0-5% | 0.01-1% |
| Dipotassium Phosphate | 0-5% | 0.01-1% |
| Corn Syrup | 0-20% | 0.5-10% |
| Polysorbate 60 | 0-5% | 0.01-1% |
| Sugar | 0-50% | 1-35% |
| Sodium Caseinate | 0-5% | 0.01-2% |
| Palm Oil | 0-20% | 0.5-15% |
| Artificial Flavor | 0-5% | 0.01-1% |
| Natural & Artificial Flavor(s) | 0-5% | 0.01-2% |
| Natural Non-Nutritive Sweetener(s) | 1 ppm-5% | 2 ppm-1% |

TABLE 2
Sugar Free Flavored Creamer

| INGREDIENT | APPROXIMATE RANGE | EXAMPLE RANGE |
|---|---|---|
| Water | Balance | Balance |
| Carrageenan | 0-5% | 0.01-1% |
| Mono & Diglycerides | 0-5% | 0.01-1% |
| Sodium Stearoyl Lactylate | 0-5% | 0.01-1% |
| Polysorbate 60 | 0-5% | 0.01-1% |
| Cellulose Gel/Cellulose Gum | 0-5% | 0.01-1% |
| Dipotassium Phosphate | 0-5% | 0.01-1% |
| Corn Syrup | 0-20% | 0.5-10% |
| Maltodextrin | 0-5% | 0.01-2% |
| Sodium Caseinate | 0-5% | 0.01-2% |
| Palm Oil | 0-20% | 0.5-15% |
| Artificial Flavor | 0-5% | 0.01-1% |
| Natural & Artificial Flavor(s) | 0-5% | 0.01-2% |
| Vanillin | 0-5% | 0.01-1% |
| Natural Non-Nutritive Sweetener(s) | 1 ppm-5% | 2 ppm-1% |

Embodiments of the present disclosure may add or omit certain ingredients and/or increase or decrease the amount of each ingredient in order to yield the desired properties.

At step 204, the non-dairy base may be introduced into the mixing chamber. In certain embodiments, the non-dairy base may be heated to a temperature greater than 100° F., greater than 120° F., or greater than 160° F. to facilitate mixing with the other ingredients. The other ingredients may be added to the mixing chamber at step 206. As noted above, ingredients 40 may be added serially, collectively, or a combination of both.

At step 208, the non-dairy base and other ingredients may be mixed or combined in any appropriate manner to facilitate the dispersing the ingredients substantially evenly throughout and dissolution of the dry ingredients in the mixture. For example, mechanical agitators, pressure jets, or other suitable mixing devices may be used to stir, mix, blend, agitate, or otherwise combine the ingredients. As another example, the ingredients may be stirred or mixed by hand. Mixing may continue until the ingredients are distributed substantially evenly throughout the product.

At step 210, the mixture may be discharged from the mixing chamber. The product may then be directed to processing components, such as a pasteurizer and/or a homogenizer. The finished product may be packaged and stored in refrigerated or unrefrigerated storage. In some embodiments, the flavor and texture of the finished product may be substantially maintained throughout the shelf-life of the product. As an example, the shelf-life of the non-dairy creamer may be between approximately 1 week to 1 year, such as 3 to 6 months, if the package is unopened or 1 to 3 weeks after opening the package.

The method of producing a food additive using a natural non-nutritive sweetener may yield a formulation having fewer calories than other formulations sweetened primarily with nutritive sweeteners (e.g., sugar). For example, a non-dairy creamer formulated according to certain embodiments may have less than approximately 40 calories per 1 tbsp serving, such as between 0 to 30 calories or 5 to 20 calories per serving, compared to approximately 30 to 50 calories per serving for a similar non-dairy creamer sweetened to a comparable sweetness level using only nutritive sweeteners. In some embodiments, the non-dairy base may comprise water or other fat free base in order to maintain a low calorie level in the product.

The steps illustrated in FIG. 2 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A non-dairy food additive, comprising:
a non-dairy cream including:
a non-dairy base;
a natural non-nutritive sweetener selected to provide a sweet taste to the non-dairy cream; and
one or more stabilizers selected to facilitate maintaining the non-dairy cream in a substantially uniform liquid suspension.

2. The non-dairy food additive of claim 1, wherein the non-dairy base comprises water and the one or more stabilizers include a hydrocolloid, a salt, a protein, and a lipid.

3. The non-dairy food additive of claim 1, wherein:
the natural non-nutritive sweetener comprises stevia, a stevia derivative, luo han guo, or a luo han guo derivative; and
the natural non-nutritive sweetener present in an amount between approximately 1 ppm-5% of the non-dairy cream.

4. The non-dairy food additive of claim 1, the ingredients further comprising a nutritive sweetener present in an amount less than 45% of the non-dairy cream.

5. The non-dairy food additive of claim 1, wherein the one or more stabilizers include:
at least one hydrocolloid selected from the group consisting of guar, acacia, locust bean, xanthan, gellan, carrageenan, cellulose, and pectin;
at least one salt selected from the group consisting of sodium stearoyl lactylate, sodium citrate, sodium chloride, potassium citrate, potassium phosphate, and dipotassium phosphate; and
at least one lipid selected from the group consisting of monoglycerides, diglycerides, and one or more vegetable oils.

6. The non-dairy food additive of claim 1, wherein:
the non-dairy base comprises water;
the natural non-nutritive sweetener comprises stevia or a steviol glycoside;
the one or more stabilizers include:
one or more hydrocolloids present in an amount between approximately 0.02 and 2% of the non-dairy cream, the one or more hydrocolloids selected from the group consisting of guar, acacia, locust bean, xanthan, gellan, carrageenan, cellulose, and pectin;
one or more salts present in an amount between approximately 0.02 and 2% of the non-dairy cream, the one or more salts selected from the group consisting of sodium stearoyl lactylate, sodium citrate, sodium chloride, potassium citrate, potassium phosphate, and dipotassium phosphate; and
one or more lipids present in an amount between approximately 0.5 and 15% of the non-dairy cream, the one or more lipids selected from the group consisting of monoglycerides, diglycerides, and one or more vegetable oils; and
the non-dairy food additive further comprises a nutritive sweetener in an amount between approximately 0.5 and 45% of the non-dairy cream.

7. The non-dairy food additive of claim 1, wherein:
the non-dairy base comprises a reduced-fat or fat free non-dairy base; and
the non-dairy cream includes less than approximately 40 calories per tablespoon.

8. The non-dairy food additive of claim 1, wherein:
the natural non-nutritive sweetener comprises luo han guo, a mogroside, stevia, or a steviol glycoside; and
further comprising:
a nutritive sweetener;
a flavor selected from the group consisting of amaretto, chocolate, cocoa, toffee, almond, vanilla, hazelnut, caramel, Irish crème, butter pecan, mint, cinnamon, pumpkin, strawberry, or raspberry.

9. The non-dairy food additive of claim 1, wherein:
the one or more stabilizers include:
carrageenan present in an amount less than 1% of the non-dairy cream;
dipotassium phosphate present in an amount less than 1% of the non-dairy cream;
a combination of monoglycerides and diglycerides present in an amount less than 1% of the non-dairy cream;
palm oil present in an amount less than 15% of the non-dairy cream;
polysorbate 60 present in an amount less than 1% of the non-dairy cream;
sodium caseinate present in an amount less than 2% of the non-dairy cream; and
sodium stearoyl lactylate present in an amount less than 1% of the non-dairy cream; and
further comprising a flavor selected from the group consisting of amaretto, chocolate, cocoa, toffee, almond, vanilla, hazelnut, caramel, Irish crème, butter pecan, mint, cinnamon, pumpkin, strawberry, or raspberry.

10. The non-dairy food additive of claim 1, wherein the one or more stabilizers are selected to facilitate maintaining the non-dairy cream in a substantially uniform liquid suspension for a shelf-life between approximately 1 week and 1 year.

11. The non-dairy food additive of claim 1, wherein the one or more stabilizers are selected to facilitate maintaining the non-dairy cream in a substantially uniform liquid suspension when mixed with a hot or cold beverage-type food.

12. The non-dairy food additive of claim 1, wherein the non-dairy base comprises water, oil, a reduced-fat non-dairy milk alternative, or a fat free non-dairy milk alternative, and the non-dairy cream is substantially free of added sugar.

13. A method, comprising:
selecting ingredients, including:
a non-dairy base;
a natural non-nutritive sweetener; and
one or more stabilizers;
adding the ingredients to a mixing chamber;
mixing to yield a mixture having the ingredients dispersed substantially evenly throughout; and
processing the mixture to yield a non-dairy food additive.

14. The method of claim 13, wherein the non-dairy food additive comprises a non-dairy creamer and the one or more stabilizers selected to facilitate maintaining the non-dairy creamer in a substantially uniform liquid suspension when mixed with a hot or cold beverage-type food.

15. The method of claim 13, wherein the natural non-nutritive sweetener comprises stevia, a stevia derivative, luo han guo, or a luo han guo derivative.

16. The method of claim 13, wherein the natural non-nutritive sweetener comprises approximately 1 ppm-5% of the mixture.

17. The method of claim 13, the ingredients further comprising a nutritive sweetener present in an amount less than 45% of the formulation.

18. The method of claim 13, wherein the processing the mixture includes:
heating the mixture to a pasteurization temperature between approximately 160 and 320 ° F.;
holding the mixture at the pasteurization temperature for approximately 1 to 30 seconds; and
homogenizing the mixture.

19. The method of claim 13, wherein:
the non-dairy food additive comprises a non-dairy creamer;
the natural non-nutritive sweetener comprises luo han guo, a mogroside, stevia, or a steviol glycoside; and
further comprising:
a nutritive sweetener;
a flavor selected from the group consisting of amaretto, chocolate, cocoa, toffee, almond, vanilla, hazelnut, caramel, Irish crème, butter pecan, mint, cinnamon, pumpkin, strawberry, or raspberry.

20. The method of claim 13, wherein:
the non-dairy food additive comprises a non-dairy creamer including less than approximately 40 calories per tablespoon.
